(19) United States
(12) Patent Application Publication
(10) Pub. No.: US 2024/0394378 A1
(43) Pub. Date: Nov. 28, 2024

(54) SYSTEMS AND METHODS FOR CROSS-DOMAIN SOFTWARE PRODUCT AND SOFTWARE PRODUCT METADATA DELIVERY

(71) Applicant: Palantir Technologies Inc., Denver, CO (US)

(72) Inventors: Benjamin Jackson, Arlington, VA (US); David Schlosnagle, Vienna, VA (US); Daniel Grim, New York, NY (US); Ian Reardon, Long Island City, NY (US); Johnny Huang, New York, NY (US); Robert Blount, Short Hills, NY (US); Sean Hacker, Washington, DC (US); Steven McDonald, Arlington, VA (US)

(21) Appl. No.: 18/669,167

(22) Filed: May 20, 2024

Related U.S. Application Data
(60) Provisional application No. 63/468,652, filed on May 24, 2023.

(51) Int. Cl. G06F 21/57; G06F 8/60

(52) U.S. Cl. CPC G06F 21/577; G06F 8/60; G06F 2221/033

(57) ABSTRACT

Systems and methods for software product deployment and/or compliance management are provided. In some embodiments, a method includes: receiving an indication of a first payload of a software deployment package; performing a first software scan of the first payload; generating a first integrity file including an indication of integrity based upon the first software scan; and triggering a transfer of the first payload and the first integrity file from a first network domain to a second network domain different from the first network domain.

### CROSS REFERENCE TO RELATED APPLICATIONS

This application claims priority to U.S. Provisional Application No. 63/468,652, filed May 24, 2023, which is incorporated by reference herein for all purposes.

### TECHNICAL FIELD

Certain embodiments of the present disclosure are directed to software delivery. More particularly, some embodiments of the present disclosure provide systems and methods for cross-domain software delivery.

### BACKGROUND

Software deployment and/or delivery can be important to keep software up to date. In some examples, software deployment and/or delivery can be complex and time-consuming, depending on the security and/or compliance requirements. Hence it is desirable to improve the techniques for software deployment and/or delivery.

### SUMMARY

Certain embodiments of the present disclosure are directed to software delivery. More particularly, some embodiments of the present disclosure provide systems and methods for cross-domain software delivery.

According to some embodiments are directed to a method for software product deployment and compliance management, the method comprising: receiving an indication of a first payload of a software deployment package; performing a first software scan of the first payload; generating a first integrity file including an indication of integrity based upon the first software scan; and triggering a transfer of the first payload and the first integrity file from a first network domain to a second network domain different from the first network domain; wherein the method is performed using one or more processors.

According to certain embodiments are directed to a system for software product deployment and compliance management, the system comprising: one or more memories comprising instructions stored thereon; and one or more processors configured to execute the instructions and perform operations comprising: receiving an indication of a first payload of a software deployment package; performing a first software scan of the first payload; generating a first integrity file including an indication of integrity based upon the first software scan; and triggering a transfer of the first payload and the first integrity file from a first network domain to a second network domain different from the first network domain.

According to some embodiments are directed to a non-transitory machine readable storage medium storing instructions for software product deployment and compliance management, wherein the instructions, when executed by one or more processors, cause the one or more processors to perform operations comprising: receiving an indication of a first payload of a software deployment package; performing a first software scan of the first payload; generating a first integrity file including an indication of integrity based upon the first software scan; and triggering a transfer of the first payload and the first integrity file from a first network domain to a second network domain different from the first network domain.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is an illustrative diagram for a software deployment and compliance management environment or workflow, according to certain embodiments of the present application.

FIGS. 2A and 2B illustrate a simplified diagram showing a method for cross-domain software deployment and compliance management according to certain embodiments of the present disclosure.

FIG. 3 illustrates example software deployment package types according to certain embodiments of the present disclosure.

FIG. 4 is an example mini payload (e.g., a payload manifest corresponding to a package) according to certain embodiments of the present disclosure.

FIG. 5 illustrates some examples of software scanning according to certain embodiments of the present disclosure.

FIG. 6 is a simplified diagram showing a computing system for implementing a system for cross-domain software deployment and compliance management in accordance with at least one example set forth in the disclosure.

### DETAILED DESCRIPTION

Certain embodiments of the present disclosure are directed to software delivery. More particularly, some embodiments of the present disclosure provide systems and methods for cross-domain software delivery.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods manually deliver software products across different networks, for example, with a barrier (e.g., across a commercial network and a government network). According to some embodiments, traditional software delivery across networks, for example, in the government context, can take hours from end-to-end. For example, this can include processes that require manual operations by a user (e.g., Data Transfer Officers (DTOs)) to burn files to DVDs and scan them multiple times. In certain embodiments, these processes are also error-prone because of their manual nature, and can also cause software delivery to fall behind by days.

Various embodiments of the present disclosure can achieve benefits and/or improvements by computing systems and/or software (e.g., implemented on computing devices across different networks) for software deployments, for example, to automate the process (e.g., down to minutes). In some embodiments, benefits include significant improvements, including, for example, increased efficiency, reduced complexity, and improved scalability, in deploying features, conducting feature rollbacks (e.g., product rollbacks) configuration changes, and/or other software deployment-related operations. In certain embodiments, benefits include improved security and/or reduced software vulnerability of software deployment across domains.

At least some embodiments of the present disclosure are directed to systems and methods configured to coordinate software products and software product metadata delivery across a CDS (cross-domain solution), for example, by cross-domain deployment and compliance management software. In certain embodiments, the cross-domain deployment and compliance management software (e.g., a software module, a software system, etc.) integrates natively with the software deployment platform and/or software supply chain management system to acquire the desired software products (e.g., the latest software products) and software product metadata that a different network's deployment system, for example, requiring to stay up-to-date and deploy the latest software to production environments more quickly. In some embodiments, the cross-domain deployment and compliance management software is configured to take the software product deployment package (e.g., bytes) and coordinate with a CDS, such as AWS (Amazon Web Service) Diode, to ship the software deployment package, also referred to as the software product deployment package, from one network to another. In certain embodiments, after the cross-domain solution has transferred the software product deployment package, the cross-domain deployment and compliance management software then coordinates with the cross-domain solution and the software deployment solution on the other network to load the software deployment package and related information into the software deployment solution.

According to certain embodiments, the cross-domain deployment and compliance management software includes one or more advanced features that may be required depending on compliance requirements (e.g., compliance regulations). For example, certain government requirements state that the software product deployment package (e.g., bytes) transferring from one network to another must be virus and vulnerability scanned on one or both networks. In some embodiments, the cross-domain deployment and compliance management software is able to run these operations and control deployment packages (e.g., quarantine payloads) that fail to pass these scans. In certain embodiments, the cross-domain deployment and compliance management software can generate one or more alerts (e.g., to alert operators) to one or more issues with scanning as well as one or more alerts for other breakdowns in the pipeline as the software deployment package transfer across networks. In some embodiments, the cross-domain deployment and compliance management software is configured to encrypt one or more software deployment packages and/or metadata (e.g., payloads) to ensure that they are not tampered with during the CDS process.

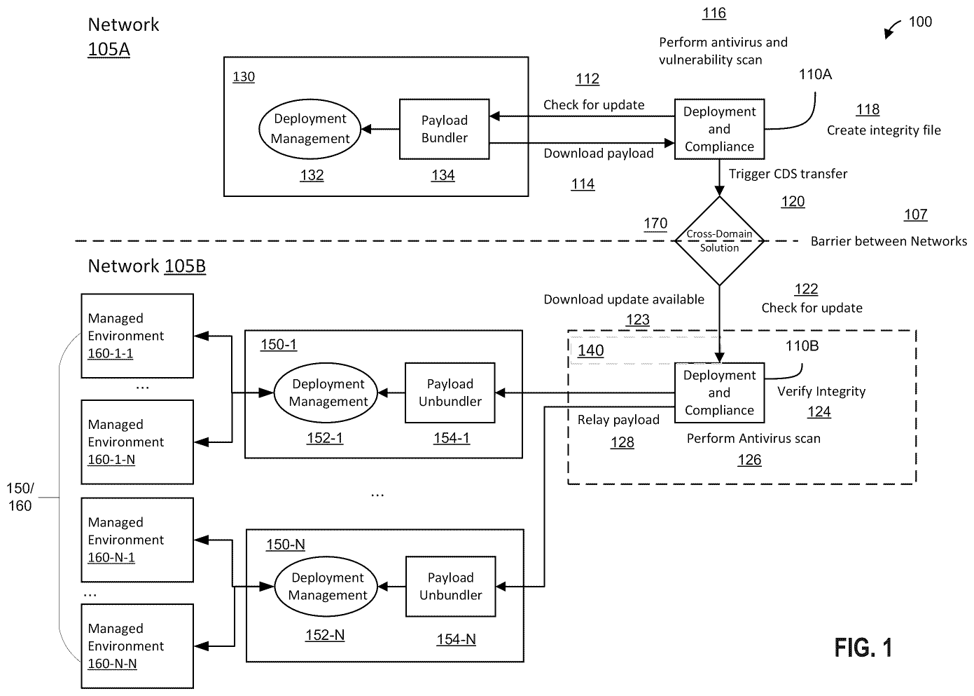

FIG. 1 is an illustrative diagram for a software deployment and compliance management environment or workflow 100, according to certain embodiments of the present application. FIG. 1 is merely an example. One of the ordinary skilled in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, the software deployment and compliance management environment or workflow 100 includes a network domain 105A and a network domain 105B, and a barrier between networks 107. In certain embodiments, the network domain 105A is a commercial domain and/or a domain for an organization. In some embodiments, the network domain 105B is a regulated domain (e.g., a domain with heightened security and compliance requirements). In certain embodiments, the barrier 107 includes one or more differences in security requirements and/or compliance requirements between the network domain 105A and the network domain 105B. In some embodiments, the networks domains 105A and 105B include one or more different security requirements (e.g., security levels) and/or compliance requirements (e.g., compliance levels).

According to some embodiments, the software deployment and compliance management environment 100 includes a software deployment system 130, a cross-domain deployment and compliance management software 110A (e.g., a software solution, a software module, a software module or solution run on a software system, etc.), a deployment and compliance management software 110B, a cross-domain solution 170, a cross-domain landing software 140, one or more software deployment systems 150 (e.g., software deployment systems 150-1 . . . software deployment system 150-N), and one or more managed environments 160 (e.g., managed environment 160-1-1, . . . , managed environment 160-1-N, . . . managed environment 160-N−1, . . . , managed environment 160-N−N). In some embodiments, the software deployment system 130 includes deployment management software 132 and payload bundler 134. In certain embodiments, the software deployment system 150 includes deployment management software 152 (e.g., deployment management software 152-1 . . . deployment management software 152-N) and payload unbundler 154 (e.g., payload unbundler 154-1, . . . payload unbundler 154-N).

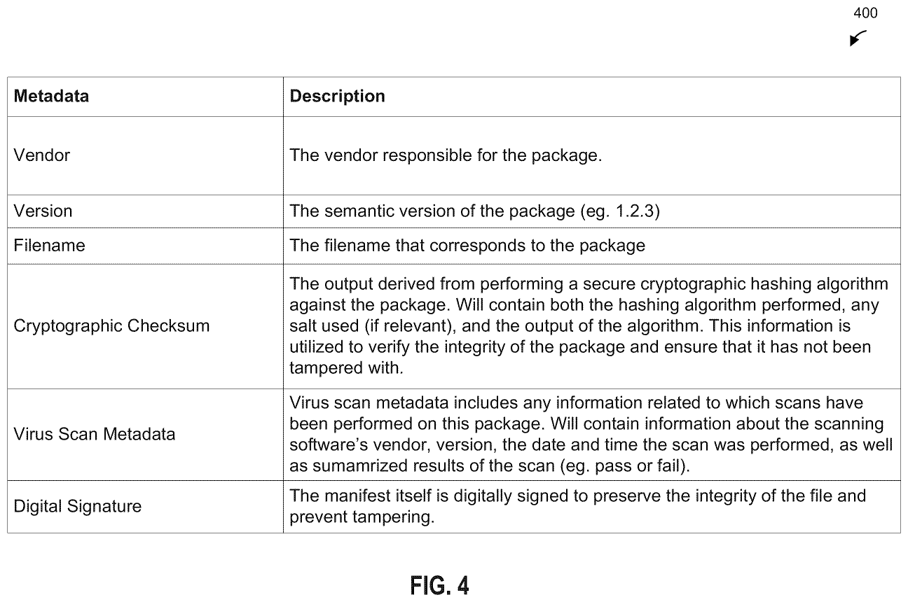

According to certain embodiments, the cross-domain deployment and compliance management software 110A and the cross-domain deployment and compliance management software 110B are instantiated of the same software. In some embodiments, the cross-domain deployment and compliance management software 110A and the cross-domain deployment and compliance management software 110B are different software. In certain embodiments, the cross-domain deployment and compliance management software 110A checks for one or more software product updates 112, for example, via the software deployment system 130 and/or the payload bundler 134. In some embodiments, if at least one software product update is found, the software deployment system 130 and/or the payload bundler 134 generate at least one corresponding software deployment package, for example, as a first payload or a comprehensive payload. In certain embodiments, the software deployment system 130 and/or the payload bundler 134 generate at least one configuration (e.g., payload manifest) for the software deployment package, for example, as a second payload or a mini payload, also referred to a payload manifest. Some example payload manifests are illustrated in FIG. 4.

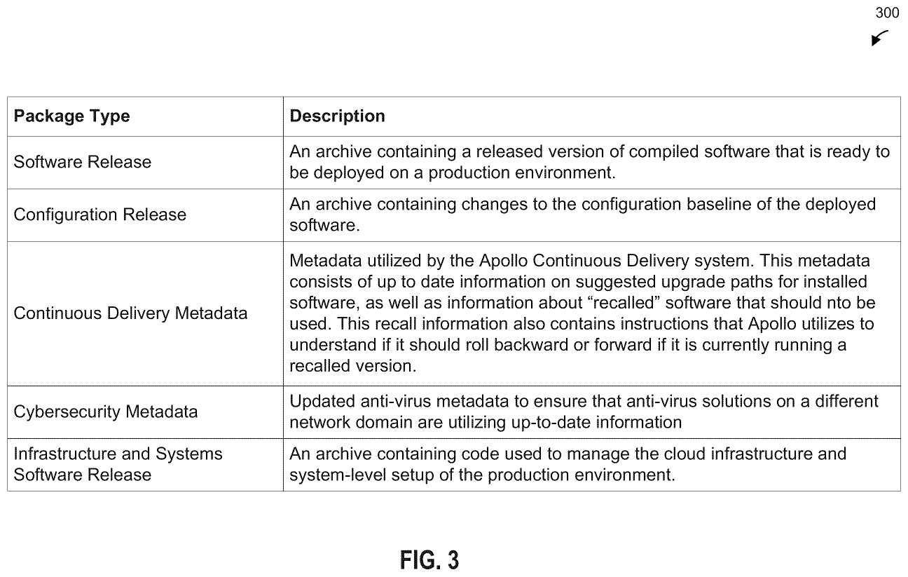

According to some embodiments, the cross-domain deployment and compliance management software 110A receives an indication of the first payload of a software deployment package. Some example software deployment packages are illustrated in FIG. 3. In certain embodiments, the cross-domain deployment and compliance management software 110A performs a first software scan of the first payload. In some embodiments, the first software scan includes an antivirus scan, for example, using antivirus software. In certain embodiments, the first software scan includes a vulnerability scan, for example, by checking the vulnerability using a list of artifacts associated with the software deployment package.

In some embodiments, the cross-domain deployment and compliance management software 110A generates a first integrity file 118 including an indication of integrity based upon the first software scan, where the first integrity file includes an indication of integrity of the first payload. In some examples, the indication of the integrity includes hashed data for the first payload. In certain embodiments, the hashed data can be generated by, for example, a hashing algorithm, a secure cryptographic hashing algorithm, and/or the like. In certain embodiments, the cross-domain deployment and compliance management software 110A and/or the cross-domain solution 170 generates a second integrity file including an indication of integrity based upon the second software scan. In some examples, the indication of the integrity includes hashed data for the second payload. In certain embodiments, the hashed data can be generated by, for example, a hashing algorithm, a secure cryptographic hashing algorithm, and/or the like. In some embodiments, the second integrity file is generated by the cross-domain solution 170.

According to certain embodiments, the cross-domain deployment and compliance management software 110A triggers a transfer (e.g., trigger CDS transfer 120) of the first payload, the second payment, the first integrity file, and/or the second integrity file, for example, from the network domain 105A to the network domain 105B. In some embodiments, the cross-domain deployment and compliance management software 110A triggers a transfer of the first payload, the second payload, the first integrity file, and/or the second integrity file, for example, using the cross-domain solution 170. In certain embodiments, the cross-domain deployment and compliance management software 110A triggers a transfer of the first payload and the first integrity file from the first network domain 105A to the second network domain 105B different from the first network domain. In some embodiments, the cross-domain deployment and compliance management software 110A triggers a transfer of the second payload and the second integrity file from the first network domain 105A to the second network domain 105B.

According to some embodiments, the cross-domain deployment and compliance management software 110B checks payload availability (e.g., check for updates 122) in the second network domain. In certain embodiments, the cross-domain deployment and compliance management software 110B downloads a payload (e.g., the first payload, the second payload, etc.) when it is available (e.g., download update available 123). In some embodiments, the cross-domain deployment and compliance management software 110B downloads the first payload and/or the second payload. In certain embodiments, the cross-domain deployment and compliance management software 110B downloads the first payload and the second payload at two different times. In some embodiments, because of the second payload being smaller in size, the second payload is downloaded quicker.

According to certain embodiments, the cross-domain deployment and compliance management software 110B verifies a first integrity of the downloaded first payload based at least in part on the first integrity file (e.g., verify integrity 124) and/or verifies a second integrity of the downloaded second payload based at least in part on the second integrity file (e.g., verify integrity 124). In certain examples, the verifying integrity 123 is to check a hash code associated with the downloaded payload. In some embodiments, the cross-domain deployment and compliance management software 110B performs a second software scan (e.g., perform antivirus scan 126) to the downloaded payload. In some embodiments, the cross-domain deployment and compliance management software 110B performs the second software scan to the downloaded first payload and/or the downloaded second payload. In certain embodiments, the second software scan includes an antivirus scan. In some embodiments, the second software scan does not include a vulnerability scan.

According to some embodiments, the cross-domain deployment and compliance management software 110B relays (e.g., provides) the downloaded first payload and/or the downloaded second payload to the software deployment system 150. In certain embodiments, the cross-domain deployment and compliance management software 110B relays the downloaded first payload and/or the downloaded second payload to the software deployment system 150 if the integrity verification satisfies one or more predetermined criteria (e.g., passing the integrity check) and/or antivirus scan indicates no virus detected. In some embodiments, the cross-domain deployment and compliance management software 110B relays (e.g., provides) the downloaded first payload and/or the downloaded second payload to two or more software deployment systems 150 that are different from each other.

According to certain embodiments, the software deployment system 150 and/or the payload unbundler are configured to extract the software deployment package and/or the configuration associated with the software deployment package from the downloaded payload. In some embodiments, the software deployment system 150 deploys the software deployment package to the managed environment 160, for example, based upon the associated configuration. In some embodiments, the software deployment system 150 deploys the software deployment package to two or more managed environments 160 that are different from each other, for example, based upon the associated configuration.

In some embodiments, the software deployment and compliance management environment 100 includes a repository (not shown) including and/or storing software deployment packages, configurations, payloads, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the software deployment and compliance management environment 100 can execute software or firmware stored in non-transitory computer-readable medium to implement various processing steps. Various components and processors of the software deployment and compliance management environment 100 can be implemented by one or more computing devices including, but not limited to, circuits, a computer, a cloud-based processing unit, a processor, a processing unit, a microprocessor, a mobile computing device, and/or a tablet computer. In some cases, various components of the software deployment and compliance management environment 100 (e.g., the cross-domain deployment and compliance software solution 110A/110B, the software deployment system 130, the software deployment system 150, etc.) can be implemented on a shared computing device. Alternatively, a component of the cross-domain software deployment and compliance management environment 100 can be implemented on multiple computing devices. In some implementations, various modules and components of the cross-domain software deployment and compliance management environment or workflow 100 can be implemented as software, hardware, firmware, or a combination thereof. In some cases, various components of the cross-domain software deployment and compliance management environment or workflow 100 can be implemented in software or firmware executed by a computing device.

Various components of the software deployment and compliance management environment or workflow 100 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

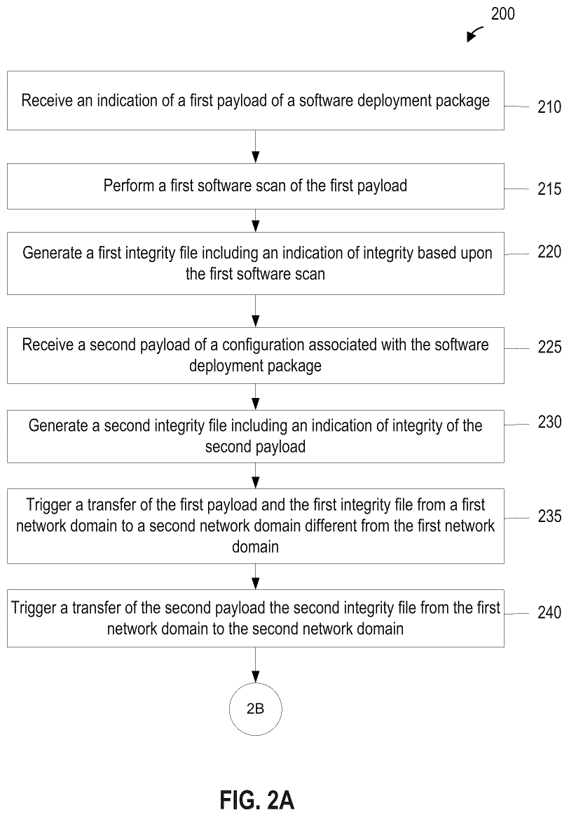

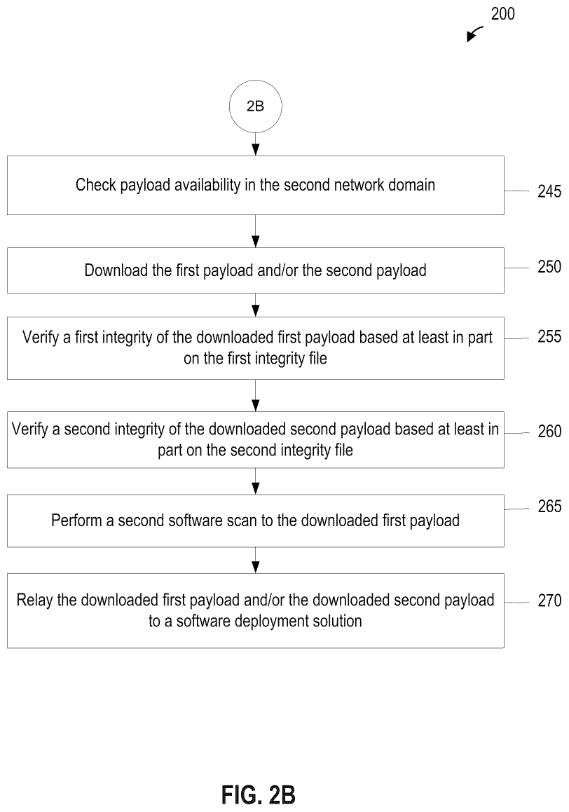

FIGS. 2A and 2B illustrate a simplified diagram showing a method 200 for cross-domain software deployment and compliance management according to certain embodiments of the present disclosure. This diagram is merely an example. One of ordinary skill in the art would recognize many variations, alternatives, and modifications. The method 200 for cross-domain software deployment and compliance management includes processes 210, 215, 220, 225, 230, 235, 240, 245, 250, 255, 260, 265, and 270. Although the above has been shown using a selected group of processes for the method 200 for cross-domain software deployment and compliance management, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 200 are performed by a system (e.g., the computing system 600). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 1000 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, the system checks for one or more software product updates, for example, via the software deployment system and/or the payload bundler. In some embodiments, if at least one software product update is found, the software deployment system and/or the payload bundler generate at least one corresponding software deployment package, for example, as a first payload or a comprehensive payload. In certain embodiments, the software deployment system and/or the payload bundler generate at least one configuration for the software deployment package, for example, as a second payload or a mini payload.

According to some embodiments, at process 210, the system receives an indication of the first pay load of a software deployment package. In certain embodiments, at process 215, the system performs a first software scan of the first payload. In some embodiments, the first software scan includes an antivirus scan, for example, using antivirus software. In certain embodiments, the first software scan includes a vulnerability scan, for example, by checking the vulnerability using a list of artifacts associated with the software deployment package.

In some embodiments, at process 220, the system generates a first integrity file including an indication of integrity based upon the first software scan, where the first integrity file includes an indication of integrity of the first payload. In some examples, the indication of the integrity includes hashed data for the first payload. In certain embodiments, at process 225, the system receives a second payload of a configuration associated with the software deployment package. In certain embodiments, at process 230, the system and/or the cross-domain solution generates a second integrity file including an indication of integrity based upon the second software scan. In some examples, the indication of the integrity includes hashed data for the second payload. In some embodiments, the second integrity file is generated by the cross-domain solution.

According to certain embodiments, the system triggers a transfer of the first payload, the second payment, the first integrity file, and/or the second integrity file, for example, from the first network domain to the second network domain. In some embodiments, the system triggers a transfer of the first payload, the second payload, the first integrity file, and/or the second integrity file, for example, using the cross-domain solution. In certain embodiments, at process 235, the system triggers a transfer of the first payload and the first integrity file from the first network domain to the second network domain different from the first network domain. In some embodiments, at process 240, the system triggers a transfer of the second pay load and the second integrity file from the first network domain to the second network domain.

According to some embodiments, at process 245, the system checks payload availability in the second network domain. In certain embodiments, he system downloads a payload (e.g., the first pay load, the second payload, etc.) when it is available (e.g., download update available). In some embodiments, at process 250, the system downloads the first payload and/or the second payload. In certain embodiments, the system downloads the first payload and the second payload at two different times. In some embodiments, because of the second payload being smaller in size, the second payload is downloaded quicker.

According to certain embodiments, at process 255, the system verifies a first integrity of the downloaded first payload based at least in part on the first integrity file) and/or at process 260, verifies a second integrity of the downloaded second payload based at least in part on the second integrity file. In certain examples, the verifying integrity includes to check a hash code associated with the downloaded payload. In some embodiments, at process 265, the system performs a second software scan (e.g., perform antivirus scan to the downloaded payload. In some embodiments, the system performs the second software scan to the downloaded first payload and/or the downloaded second payload. In certain embodiments, the second software scan includes an antivirus scan. In some embodiments, the second software scan does not include a vulnerability scan, for example, to improve software deployment efficiency.

According to some embodiments, at process 270, the system relays (e.g., provides) the downloaded first payload and/or the downloaded second payload to the software deployment system. In certain embodiments, the system relays (e.g., provides) the downloaded first payload and/or the downloaded second payload to the software deployment system if the integrity verification satisfies one or more predetermined criteria (e.g., passing the integrity check) and/or antivirus scan indicates no virus detected. In some embodiments, the system relays the downloaded first payload and/or the downloaded second payload to two or more software deployment systems that are different from each other.

According to certain embodiments, the software deployment system and/or the payload unbundler are configured to extract the software deployment package and/or the configuration associated with the software deployment package the downloaded payload. In some embodiments, the software deployment system 150 deploys the software deployment package to the managed environment, for example, based upon the associated configuration. In some embodiments, the software deployment system deploys the software deployment package to two or more managed environments that are different from each other, for example, based upon the associated configuration.

According to some embodiments, the software deployment system can facilitate the transfer of software releases from a first cloud environment (e.g., commercial cloud) to a second cloud environment (e.g., a cloud environment having higher compliance requirement(s), a high-side cloud). In certain embodiments, the ability to provide cross-domain software delivery functionality would not only serve to increase current data-transfer process resiliency, but would greatly reduce the time between new functionality and security patches being released by our product development team and deployment at our customers.

According to certain embodiments, systems and methods are designed to ensure the integrity and security of the binaries that are being transferred via a cross-domain solution. In some embodiments, the product development team undertakes every day, through our automated publishing and scanning routine for pushing data into deployment, and finally with the additional scanning and quarantine procedures that will take place within the restrictive cloud environment, as well as the automated installation and recall procedures in software delivery pipeline.

According to some embodiments, cross-domain customers would be able to receive software updates with requested features and critical security patches at the speed of the mission. In certain embodiments, this will serve to simultaneously increase the overall security of the environment while also tightening the feedback loop, providing customers with requested features to meet their mission requirements.

According to certain embodiments, the software deployment packages (e.g., binary packages) transferred across security domains, for example, via a cross-domain solution, are composed of several types of data as outlined below. In some embodiments, regardless of the contents of the package, the same automated process and technical safeguards will be utilized to protect and verify the integrity of the data as it moves from one network domain to another network domain.

FIG. 3 illustrates example software deployment package types 300 according to certain embodiments of the present disclosure. FIG. 3 is merely an example. One of the ordinary skilled in the art would recognize many variations, alternatives, and modifications. In certain embodiments, a software release package includes an archive containing a released version of compiled software that is ready to be deployed in a production environment. In some embodiments, a configuration release package includes an archive containing changes to the configuration baseline of the deployed software.

According to certain embodiments, a continuous delivery metadata package includes metadata utilized by a software deployment system. In some embodiments, the continuous delivery metadata includes up-to-date information on suggested upgrade paths for installed software, as well as information about “recalled” software that should not be used. In certain embodiments, this recall information also contains instructions that the software deployment system utilizes to understand if it should roll backward or forward if it is currently running a recalled version.

According to some embodiments, a cybersecurity metadata package includes updated antivirus metadata to ensure that a second network domain (e.g., high-side network) anti-virus solutions are always utilizing up-to-date information. In certain embodiments, an infrastructure and systems software release package includes an archive containing code used to manage the cloud infrastructure and system-level setup of the production environment.

FIG. 4 is an example mini payload (e.g., a payload manifest corresponding to a package) 400 according to certain embodiments of the present disclosure. FIG. 4 is merely an example. One of the ordinary skilled in the art would recognize many variations, alternatives, and modifications. In some embodiments, every package (e.g., a first payload, a comprehensive payload) is transferred alongside a corresponding payload manifest file (e.g., a second payload, a mini payload). In certain embodiments, the payload manifest includes one or more of the following information: 1) vendor information, which is the vendor responsible for the package; 2) version information, which is the semantic version of the package (e.g., version. 1.2.3): 3) filename, which corresponds to the package; 4) cryptographic checksum, which is the output derived from performing a secure cryptographic hashing algorithm against the package; 5) virus scan metadata includes any information related to which scans have been performed on the package; and/or 6) digital signature, where the manifest itself is digitally signed to preserve the integrity of the file and prevent tampering.

In some embodiments, the cryptograph checksum contains the hashing algorithm performed. In certain embodiments, the cryptograph checksum includes any salt used (if relevant), and the output of the algorithm. In some embodiments, this information is utilized to verify the integrity of the package and ensure that it has not been tampered with. In certain embodiments, the virus scan metadata includes information about the scanning software's vendor, version, the date and time the scan was performed, as well as the summarized results of the scan (e.g., pass or fail), and/or the like.

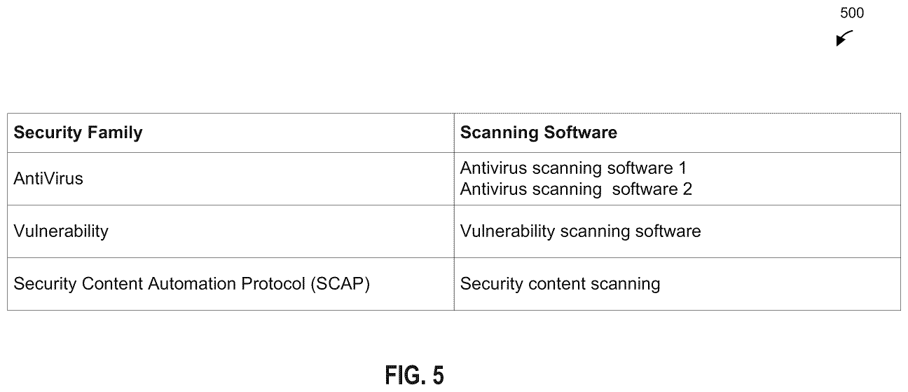

FIG. 5 illustrates some examples of software scanning 500 according to certain embodiments of the present disclosure. FIG. 5 is merely an example. One of the ordinary skilled in the art would recognize many variations, alternatives, and modifications. In some embodiments, the software scanning includes using one or more antivirus scanning software, one or more vulnerability scanning software, and/or one or more security content scanning.

According to certain embodiments, a software deployment system maintains a catalog which automatically learns which versions of services are available from the artifact repository and is informed of the current state of service installations by agents running alongside those installations and applies upgrades subject to certain rules; for instance, major upgrades may require longer soak times, while patches or bug fixes can be rolled out more quickly. In some embodiments, the software deployment system then validates the existence of an artifact scan output for each artifact before allowing the artifact into the catalog.

According to some embodiments, the software deployment system automatically adjudicates releases by observing performance metrics and error states, and then gradually rolls out releases that pass adjudication to the fleet, starting with internal installations and eventually reaching production environments.

According to certain embodiments, the software deployment system follows an automated recall procedure in the event that an artifact's scan output contains a vulnerability above a certain severity, with the exception of vulnerabilities that have been granted exception, for example, by a security team. In some embodiments, such change tasks due to recalling events take precedence over regular continuous delivery upgrades so that critical bug fixes get rolled out quickly. In certain embodiments, recall information is included in the continuous delivery metadata that will be transferred via the cross-domain solution.

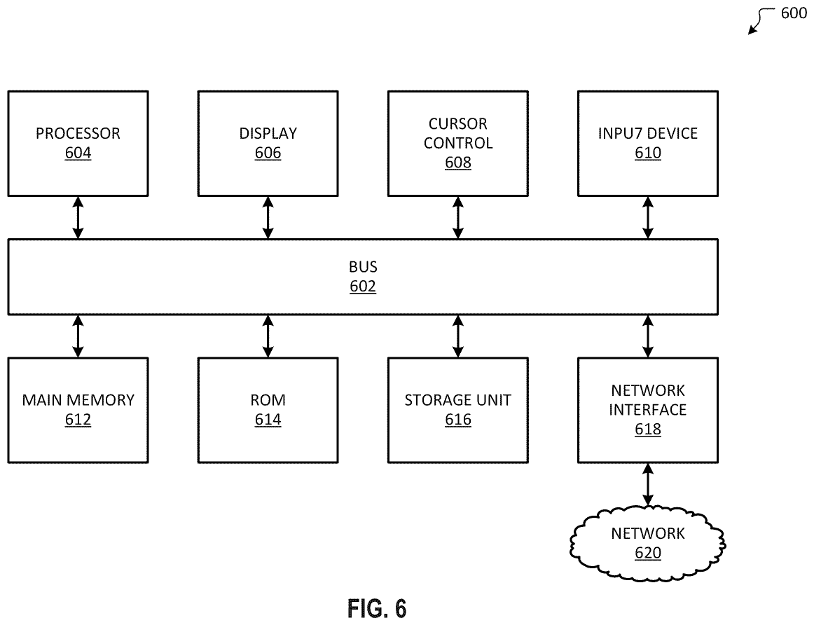

FIG. 6 is a simplified diagram showing a computing system for implementing a system 600 for cross-domain software deployment and compliance management in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the method 200 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For examples, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to some embodiments, a method for software deployment and compliance management, the method comprising: receiving an indication of a first payload of a software deployment package; performing a first software scan of the first payload; generating a first integrity file including an indication of integrity based upon the first software scan; and triggering a transfer of the first payload and the first integrity file from a first network domain to a second network domain different from the first network domain; wherein the method is performed using one or more processors. For example, the method is implemented according to at least FIG. 1, FIG. 2, and/or FIG. 3.

In certain embodiments, the method further comprises: receiving a second payload of a configuration associated with the software deployment package; generating a second integrity file including an indication of integrity of the second payload; and triggering a transfer of the second payload the second integrity file from the first network domain to the second network domain. In some embodiments, the method further comprises: checking payload availability in the second network domain; and downloading the first payload and the second payload. In certain embodiments, the first payload and the second payload are downloaded at two different times. In some embodiments, the method further comprises: verifying a first integrity of the downloaded first payload based at least in part on the first integrity file; and verifying a second integrity of the downloaded second payload based at least in part on the second integrity file.

In some embodiments, the method further comprises: relaying the downloaded first payload or the downloaded second payload to a software deployment solution. In certain embodiments, the first software scan includes an anti-virus scan and a vulnerability scan. In some embodiments, the method further comprises: performing a second software scan to the downloaded first payload. In certain embodiments, the second software scan includes an antivirus scan. In certain embodiments, the second software scan does not include a vulnerability scan, for example, to improve software deployment efficiency. In some embodiments, the receiving an indication of a first payload of a software deployment package comprises: checking for an update to one or more payloads; determining the first payload being updated; and downloading the first payload.

According to some embodiments, a system for software deployment and compliance management, the system comprising one or more memories comprising instructions stored thereon; and one or more processors configured to execute the instructions and perform operations comprising: receiving an indication of a first payload of a software deployment package; performing a first software scan of the first payload; generating a first integrity file including an indication of integrity based upon the first software scan; and triggering a transfer of the first payload and the first integrity file from a first network domain to a second network domain different from the first network domain. For example, the system is implemented according to at least FIG. 1, FIG. 2, and/or FIG. 3.

In certain embodiments, the operations further comprise: receiving a second payload of a configuration associated with the software deployment package; generating a second integrity file including an indication of integrity of the second payload; and triggering a transfer of the second payload the second integrity file from the first network domain to the second network domain. In some embodiments, the operations further comprise: checking payload availability in the second network domain; and downloading the first payload and the second payload. In certain embodiments, the first payload and the second payload are downloaded at two different times. In some embodiments, the operations further comprise: verifying a first integrity of the downloaded first payload based at least in part on the first integrity file; and verifying a second integrity of the downloaded second payload based at least in part on the second integrity file.

In some embodiments, the operations further comprise: relaying the downloaded first payload or the downloaded second payload to a software deployment solution. In certain embodiments, the first software scan includes an anti-virus scan and a vulnerability scan. In some embodiments, the operations further comprise: performing a second software scan to the downloaded first payload. In certain embodiments, the second software scan includes an antivirus scan. In certain embodiments, the second software scan does not include a vulnerability scan, for example, to improve software deployment efficiency. In some embodiments, the receiving an indication of a first payload of a software deployment package comprises: checking for an update to one or more payloads; determining the first payload being updated; and downloading the first payload.

According to some embodiments, a non-transitory machine readable storage medium storing instructions for software product deployment and compliance management, wherein the instructions, when executed by one or more processors, cause the one or more processors to perform operations comprising: receiving an indication of a first payload of a software deployment package; performing a first software scan of the first payload; generating a first integrity file including an indication of integrity based upon the first software scan; and triggering a transfer of the first payload and the first integrity file from a first network domain to a second network domain different from the first network domain. For example, the non-transitory machine-readable storage medium is implemented according to at least FIG. 1, FIG. 2, and/or FIG. 3.

In certain embodiments, the operations further comprise: receiving a second payload of a configuration associated with the software deployment package; generating a second integrity file including an indication of integrity of the second payload; and triggering a transfer of the second payload the second integrity file from the first network domain to the second network domain. In some embodiments, the operations further comprise: checking payload availability in the second network domain; and downloading the first payload and the second payload. In certain embodiments, the first payload and the second payload are downloaded at two different times. In some embodiments, the operations further comprise: verifying a first integrity of the downloaded first payload based at least in part on the first integrity file; and verifying a second integrity of the downloaded second payload based at least in part on the second integrity file.

In some embodiments, the operations further comprise: relaying the downloaded first payload or the downloaded second payload to a software deployment solution. In certain embodiments, the first software scan includes an anti-virus scan and a vulnerability scan. In some embodiments, the operations further comprise: performing a second software scan to the downloaded first payload. In certain embodiments, the second software scan includes an antivirus scan. In certain embodiments, the second software scan does not include a vulnerability scan, for example, to improve software deployment efficiency. In some embodiments, the receiving an indication of a first payload of a software deployment package comprises: checking for an update to one or more payloads; determining the first payload being updated; and downloading the first payload.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for software product deployment and compliance management, the method comprising:
receiving an indication of a first payload of a software deployment package;
performing a first software scan of the first payload;
generating a first integrity file including an indication of integrity based upon the first software scan; and
triggering a transfer of the first payload and the first integrity file from a first network domain to a second network domain different from the first network domain;
wherein the method is performed using one or more processors.

2. The method of claim 1, further comprising:
receiving a second payload of a configuration associated with the software deployment package;
generating a second integrity file including an indication of integrity of the second payload; and
triggering a transfer of the second payload the second integrity file from the first network domain to the second network domain.

3. The method of claim 2, further comprising:
checking payload availability in the second network domain; and
downloading the first payload and the second payload.

4. The method of claim 3, wherein the first payload and the second payload are downloaded at two different times.

5. The method of claim 3, further comprising:
verifying a first integrity of the downloaded first payload based at least in part on the first integrity file; and
verifying a second integrity of the downloaded second payload based at least in part on the second integrity file.

6. The method of claim 5, further comprising:
relaying the downloaded first payload or the downloaded second payload to a software deployment solution.

7. The method of claim 5, wherein the first software scan includes an anti-virus scan and a vulnerability scan.

8. The method of claim 7, further comprising:
performing a second software scan to the downloaded first payload.

9. The method of claim 8, wherein the second software scan includes an antivirus scan.

10. The method of claim 8, wherein the second software scan does not include a vulnerability scan.

11. The method of claim 1, wherein the receiving an indication of a first payload of a software deployment package comprises:
checking for an update to one or more payloads;
determining the first payload being updated; and
downloading the first payload.

12. A system for software product deployment and compliance management, the system comprising:
one or more memories comprising instructions stored thereon; and
one or more processors configured to execute the instructions and perform operations comprising:
receiving an indication of a first payload of a software deployment package;
performing a first software scan of the first payload;
generating a first integrity file including an indication of integrity based upon the first software scan; and
triggering a transfer of the first payload and the first integrity file from a first network domain to a second network domain different from the first network domain.

13. The system of claim 12, wherein the operations further comprise:
receiving a second payload of a configuration associated with the software deployment package;
generating a second integrity file including an indication of integrity of the second payload; and
triggering a transfer of the second payload the second integrity file from the first network domain to the second network domain.

14. The system of claim 13, wherein the operations further comprise:
checking payload availability in the second network domain; and
downloading the first payload and the second payload.

15. The system of claim 14, wherein the first payload and the second payload are downloaded at two different times.

16. The system of claim 14, wherein the operations further comprise:
verifying a first integrity of the downloaded first payload based at least in part on the first integrity file; and
verifying a second integrity of the downloaded second payload based at least in part on the second integrity file.

17. The system of claim 16, wherein the operations further comprise:
relaying the downloaded first payload or the downloaded second payload to a software deployment solution.

18. The system of claim 16, wherein the first software scan includes an anti-virus scan and a vulnerability scan.

19. The system of claim 18, wherein the operations further comprise:
performing a second software scan to the downloaded first payload.

20. A non-transitory machine readable storage medium storing instructions for software product deployment and compliance management, wherein the instructions, when executed by one or more processors, cause the one or more processors to perform operations comprising:
receiving an indication of a first payload of a software deployment package;
performing a first software scan of the first payload;
generating a first integrity file including an indication of integrity based upon the first software scan; and
triggering a transfer of the first payload and the first integrity file from a first network domain to a second network domain different from the first network domain.
